(19) United States
(12) Patent Application Publication
(10) Pub. No.: US 2004/0040351 A1
(43) Pub. Date: Mar. 4, 2004

(54) Attachable valuables storage device

(76) Inventor: Norman Miles Alcott, San Diego, CA (US)

Correspondence Address: Norman M. Alcott, 3425 Larga Circle, San Diego, CA, 92110, US

(21) Appl. No.: 10/233,846

(22) Filed: Sep. 3, 2002

(51) Int. Cl. E05B 65/52; A45C 11/32; A44B 15/00; A47G 29/10

(52) U.S. Cl. 70/63; 70/456 R

(57) ABSTRACT

An article of manufacture for securing vehicle keys and other valuables to a permanent part of a motor vehicle includes a two-piece hollowed-out valuables storage device wherein the two pieces fit tightly together to securely hold keys and other small articles of value in the cavity formed by the two pieces. The valuables storage device is attached to the vehicle with a locking pin and padlock, as well as by a variety of other attachment methods.

### FIELD OF THE INVENTION

This invention relates generally to the field of locking and security devices and more specifically to an article of manufacture for locking, securely, vehicle keys and other valuables to a permanent part of a motor vehicle or other object.

### BACKGROUND OF THE INVENTION

Over the years, people have become more and more dependent upon their personal vehicles for transportation. However, often it is difficult or impractical to carry valuables and keys once the driver has reached his or her destination. For example, using a vehicle for transportation to the beach leaves the driver at the beach with his or her keys and valuables, such as rings or a wallet. As a result of this predicament, a number of devices currently exist to allow the driver to hide or otherwise place their valuables in their vehicles for later retrieval.

One such device that is currently available is a vehicle oriented “hidden key” device. The “hidden key” devices available for use with vehicles typically includes a metallic box equipped with a magnet that provides for the attachment of the metallic box to the vehicle “somewhere” in the under carriage, wheel well or engine well of a vehicle. While the metallic box may provide the driver with the ability to hide a key on the vehicle, the magnets often grow weak with time and thus allow the metallic box to bounce off of the vehicle while driving. Also, frequently, the driver of the vehicle must place the key inside the metallic box after arriving at the destination, thereby providing onlookers with the location of the box, facilitating their unauthorized access to the box, resulting in possible theft or damage to the vehicle or valuables. Also, the drivers may forget where they hid the metallic box. Also, the magnetic key box are relatively small in size and thus will only hold a key or two and are typically not large enough to hold the newer electronic keys, nor are they waterproof to protect the keys from harmful exposure to moisture.

Another example of currently available devices for the storage of keys and valuables is a locking box sold under the trade name “HitchDog”. This device includes a cast aluminum, single-piece, housing that inserts into a typical frame-mounted trailer hitch receptacle on a vehicle and is secured in place with a hitch locking pin. The HitchDog, however, does not include a cover, and does not establish a seal with either the hitch receptacle or the hitch locking holes, and therefore cannot provide a water/dust resistant environment for the key or other valuables. This device is designed to stay on the vehicle at all times and so any contents are exposed to whatever water, dust or road grime that leaks into the housing through the hitch pin locking holes. Because the housing cannot be sealed, the newer electronic keys are not being protected from the elements.

The hitch locking pin or rod, when used to secure the HitchDog, passes directly through the housing, or valuables cavity, severely limiting the number of items that can be placed in it, and also provides a direct pathway for dust and moisture to enter the housing. Moreover, because the locking pin passes directly through the housing where the valuables are located, it is possible that the keys or valuables can become damaged when the locking pin is installed or removed.

While the HitchDog was designed to provide a secure location for storing valuables, it nevertheless was designed such that three (3) different models must be manufactured and customers must measure their hitch receptacle to see which model they should order. This means a very large inventory must be kept on hand to accommodate different hitch types. Additional difficulty will be experienced when a user cannot see inside the HitchDog cavity so they cannot see whether or not the item of value is blocking the insertion of the locking bar. This could result in the damage to the valuables within the storage cavity if the user jams the locking bar into the hole/cavity.

In light of the above, it would be advantageous to provide a valuables storage device having a storage cavity separate from where the locking pin is inserted thereby eliminating the entrance of moisture and possible damage to the contents of the device. Also, it would be advantageous to provide a valuables storage device that is universal such that a single model will fit all types of hitch receptacles.

Additionally, it would be advantageous to provide a valuables storage device that is sealed to minimize the accumulation of water and/or road grime within the storage cavity, thereby protecting the valuables from moisture and harmful exposure to the environment.

It would also be advantageous to provide a valuables storage device that gives access to a spare key secured with a combination lock, eliminating the need to carry any key when away from the vehicle.

It would also be advantageous to provide a valuables storage device that provides security by attaching a storage cavity to a permanent part of the vehicle.

It would also be advantageous to provide a valuables storage device having different models that, while universally applicable to all vehicles, may be different sizes to hold more valuables, and that may be secured by different methods.

Other advantages of the present invention will become apparent from the following descriptions, taken in connection with the accompanying drawings, wherein, by way of illustration and example, how each embodiment of the of this invention is intended to work.

### BRIEF SUMMARY OF THE INVENTION

The primary object of the invention is to provide a simple, cost effective way to secure keys and other valuables to a vehicle by securing them to a trailer hitch receptacle, hitch ball, chain securing loop, the hole in a bumper designed to hold the hitch ball. Method of attachment is dependent upon which embodiment is used and the equipment available on the vehicle. An alternative embodiment may also be attached to other secure items, such as a gate or frame of a bicycle or motorcycle.

In accordance with a preferred embodiment of the valuables storage device of the present invention, an article of manufacture for securing vehicle keys and other valuables to a permanent part of the vehicle, or other object, is disclosed and generally designated

### BRIEF DESCRIPTION OF THE FIGURES

The nature, objects, and advantages of the present invention will become more apparent to those skilled in the art after considering the following detailed description in connection with the accompanying drawings, in which like reference numerals designate like parts throughout, and wherein:

FIG. 1 is an exploded view of a preferred embodiment of the present invention illustrating each; unassembled, individual part, and illustrating how those parts assemble to form a sealed valuables storage device for insertion into a vehicle hitch receptacle;

FIG. 2 is a perspective view of the fully assembled valuables storage device of the present invention inserted into a vehicle hitch receptacle (shown in phantom), and secured with a locking pin and padlock;

FIG. 3 is a cross sectional view of the valuables storage device of the present invention, showing the sealed storage compartment;

FIG. 4 is a photograph of the preferred embodiment of the valuables storage device of the present invention of FIGS. 1-3, and is shown installed in the hitch receptacle and secured in place with a locking pin and padlock;

FIG. 5 is a an exploded view of an alternative preferred embodiment of the present invention illustrating each, unassembled, individual part, and illustrating how those parts assemble to form a sealed valuables storage device attachable onto a vehicle ball hitch with a locking pin and padlock;

FIG. 6 is a view of a fully assembled alternative embodiment of the valuables storage device of the present invention shown securely attached to the ball hitch with a locking pin and padlock;

FIG. 7 is a photograph of an alternative embodiment of the valuables storage device of FIGS. 5 and 6, as installed on a vehicle hitch ball;

FIG. 8 is a perspective view of a fully assembled alternative embodiment of the valuables storage device as attached to a trailer hitch tow bar with the locking pin passing through the mounting hole for the hitch ball and secured with a padlock;

FIG. 9 is a photograph of the alternative embodiment of the valuables storage device of FIG. 8 as installed on a vehicle bumper with the locking pin passing through the mounting hole for the hitch ball and secured in place with a padlock;

FIG. 10 is a perspective view of a fully assembled alternative embodiment of the valuables storage device of the present invention as attached to a vehicle bumper by passing the locking pin through the hole designed to hold the hitch ball in the hitch tow bar;

FIG. 11 is a photograph of the alternative embodiment of the valuables storage device of FIG. 10 as installed on a vehicle bumper with the locking pin passing through the hole designed to hold the hitch ball in the hitch tow bar;

FIG. 12 is a photograph of the alternative embodiment of the valuables storage device of FIG. 10 as installed on the chain-securing loop of a typical hitch;

FIG. 13 is an exploded view of an alternative embodiment of the valuables storage device present invention illustrating each, unassembled, individual part, and illustrating how those parts assemble to form a sealed valuables storage device that will insert into a vehicle hitch receptacle;

FIG. 14 is a perspective view of the alternative embodiment of the valuables storage device of FIG. 13, with a portion of the fully assembled unit inserted and locked into a hitch receptacle with the hitch receptacle shown in phantom; and

FIG. 15 is a perspective view of the alternative embodiment of the valuables storage device of FIGS. 13 and 14, with a portion of the fully assembled unit inserted and locked into a hitch receptacle with a locking pin and padlock.

### DETAILED DESCRIPTION OF A PREFERRED EMBODIMENT

Detailed descriptions of the each embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure, or manner. Details of the embodiments follow:

Detailed Description of a First Embodiment

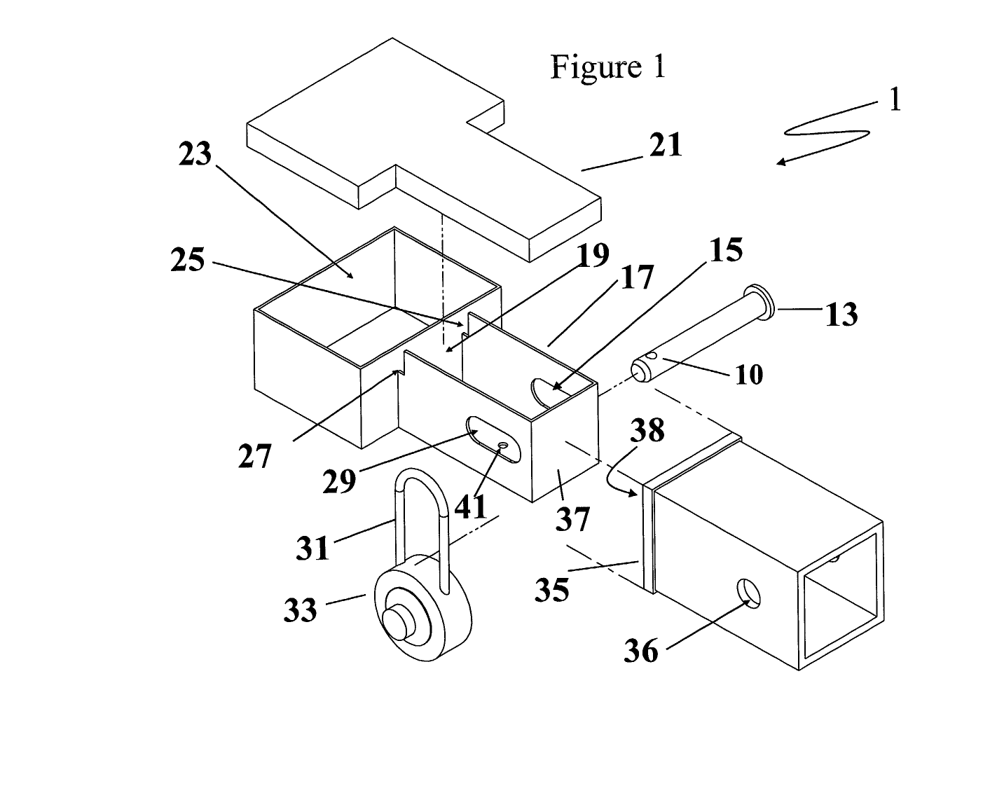

Referring initially to FIG. 1, in accordance with a preferred embodiment of the valuables storage device of the present invention, an article of manufacture for securing vehicle keys and other valuables to a permanent part of the vehicle, or other object, is disclosed and generally designated 1. In order to facilitate the understanding of this embodiment, reference numerals used in conjunction with the first embodiment are contained below in Table 1.

### Valuables Storage Device Parts List for First Embodiment

TABLE 1

| Ref. Number | Description |
|---|---|
| 10 | Locking Pin Hole |
| 13 | Locking Pin |
| 15 | Right Locking Slot |
| 17 | Lower body |
| 19 | Water Barrier |
| 21 | Overlapping lid for body |
| 23 | Cavity in lower body to secure items of value |
| 25 | Left overlapping edge, water tight seal |
| 27 | Right overlapping edge, water tight seal |
| 29 | Left locking slot |
| 31 | Padlock Shackle |
| 32 | Aligned locking slots (15 and 29) and receptacle hole (36) |
| 33 | padlock body |
| 35 | Hitch receptacle |
| 36 | Locking hole, hitch receptacle |
| 37 | Male end of unit |
| 38 | Female end of hitch receptacle |
| 40 | Fully assembled device |
| 41 | Drain hole |
| 43 | Over lapping edges |

Valuables storage device 1 includes a lower body 17 and an overlapping lid 21 that fit tightly together to form a cavity 23 sized to hold valuables securely within the cavity 23. Items of value are placed in cavity 23 of lower body 17. The over lapping lid 21 is securely fitted to the lower body 17 forming a water/dust resistant environment.

Other components of this present invention shown in the drawing include locking pin 13 sized to pass through locking hole 36 formed in the hitch receptacle 38. Locking pin 13 is formed with a locking pin hole 10 sized to receive padlock shackle 31. In a preferred embodiment, padlock 31 is a combination padlock body 33 with a changeable combination so the owner can pick their own combination. The locking slots 15 and 29 in the lower body 17 and hitch receptacle locking holes 36 are aligned to allow insertion of locking pin 13 (see Reference numeral 32). The unit is assembled by placing over lapping lid 21 on the lower body 17 and may be secured to the vehicle by placing the male end 37 into the female end 38 of the hitch receptacle 35.

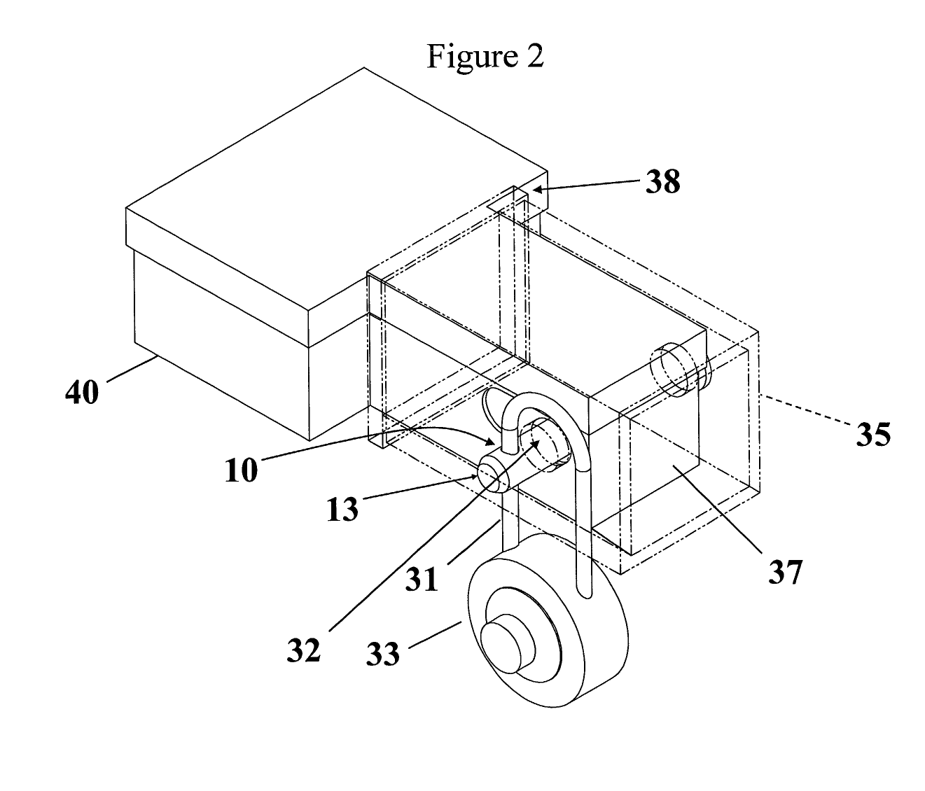

FIG. 2 shows the fully assembled device, generally designated 40, as inserted into a female end 38 of hitch receptacle 35, with the male end 37 of the device 40 being inserted first. Once the locking slots 15 and 29 are aligned with the hitch receptacle locking holes 36, the locking pin 13 is inserted through all four locking holes/slots. The padlock shackle 31 is then installed in the locking pin hole 10 and the padlock body 33 is locked. This securely attaches the fully assembled unit 40 to the vehicle.

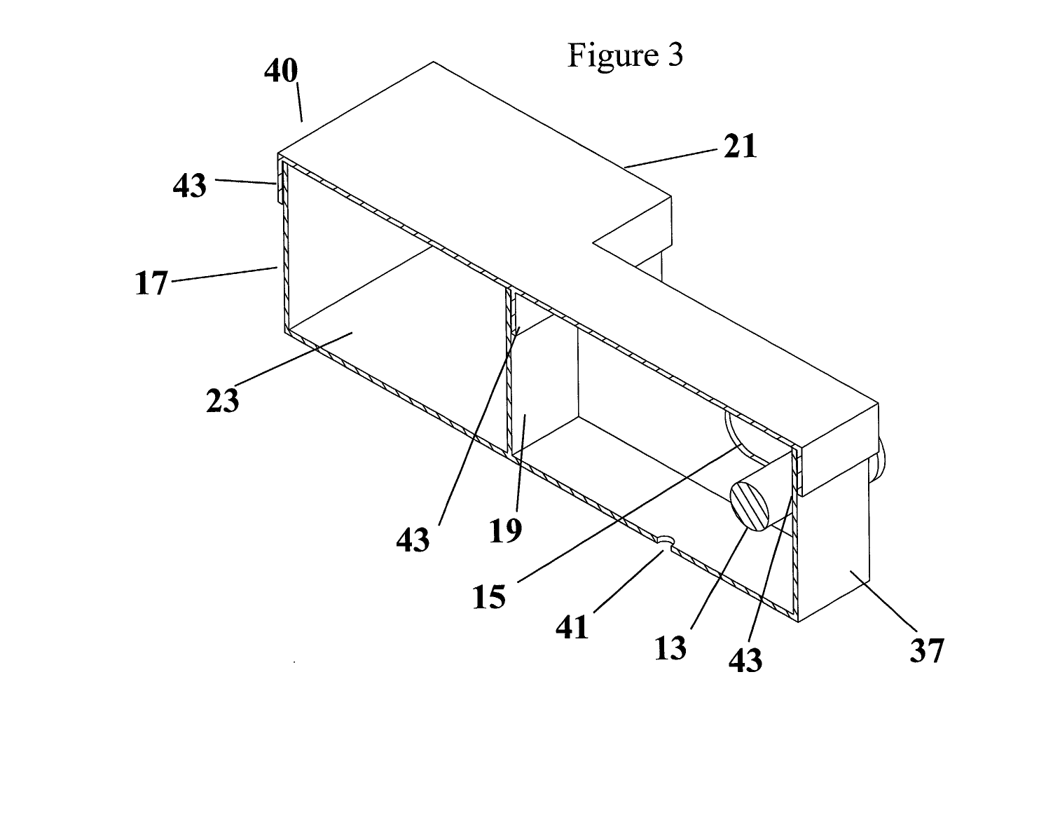

FIG. 3 is cross-sectional of the fully assembled device 40 showing over lapping edges 43 of the over lapping lid 21 as assembled with the lower body 17. It also shows a cross section of the locking pin 13 and a drain hole 41. The locking pin 13 does not necessarily fit securely in the locking slots as to be water/dust resistant, and therefore, a drain hole 41 may be provided. However, the cavity 23 is protected from water/dust by an environmental, or water, barrier 19, the water tight notches (not shown in this view), and the overlapping lid 21.

Once the two half's are fitted together the male end of the valuables storage device fits tightly into the female end of the receptacle of a trailer hitch. The male end of the valuables storage device has slots the same diameter as the holes in the trailer hitch receptacle. The locking slots in the valuables storage device and the locking holes in the trailer hitch are aligned. Then the round shaft of the locking pin is inserted through the aligned slots/holes and locked with a combination lock. The fully assembled valuables storage device is thereby secured to the vehicle, and the tight fit of the male end of the valuables storage device into the female end of the hitch receptacle keeps the valuables cavity from being pried apart. The fit of the top and bottom half is such that it will be water and dust resistant.

In a preferred embodiment, the material of manufacturer of the valuables storage device of the present invention may be galvanized sheet metal to resist tampering and weather, however, it may be cast or formed from other durable materials known in the art. The male end 37 of the valuables storage device that inserts into the hitch receptacle may be formed with a drain hole 41 in case water seeps into that compartment even though it will not affect the valuables cavity.

The cavity used to secure valuable items is effectively sealed from the elements with the over lapping top. This is particularly important due to the advent of electronic keys that provide electronic access to vehicles. These keys could malfunction if they get wet or dusty. The cost to replace these keys can be in the hundreds of dollars.

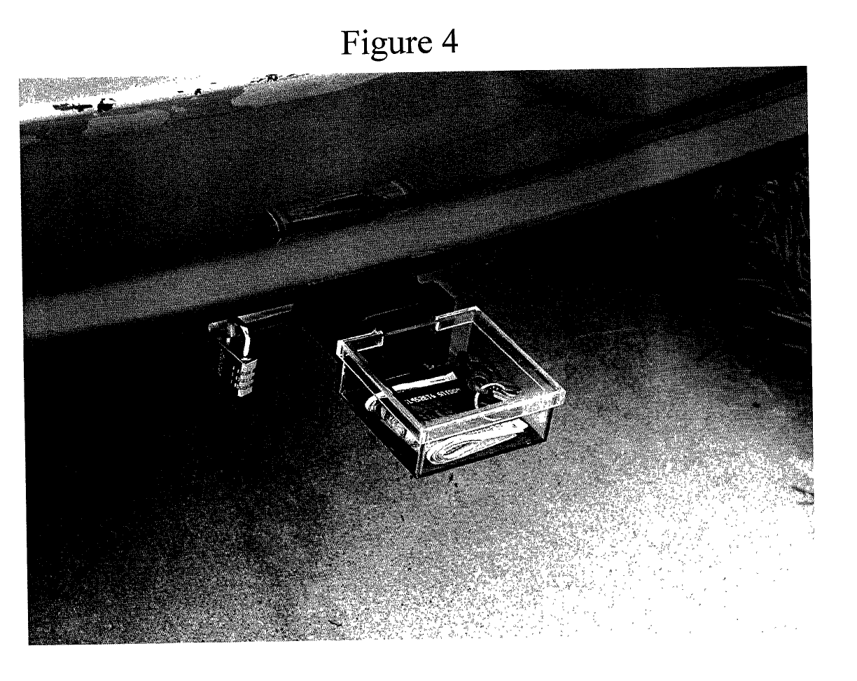

FIG. 4 is a photograph of the preferred embodiment of the valuables storage device of the present invention of FIGS. 1-3, and is shown installed in the hitch receptacle and secured in place with a locking pin and padlock. From this Figure, it is apparent that the valuables storage device 40 is securely attached to the hitch receptacle 35 of the vehicle, thereby providing a secure storage area for valuables and keys that is readily accessible to the user, but secure enough to prevent unauthorized access to those valuables and keys.

Detailed Description of a First Alternative Embodiment

In accordance with a First Alternative Embodiment of the present invention, there is disclosed an article of manufacture for securing vehicle keys and other valuables to a permanent part of the vehicle.

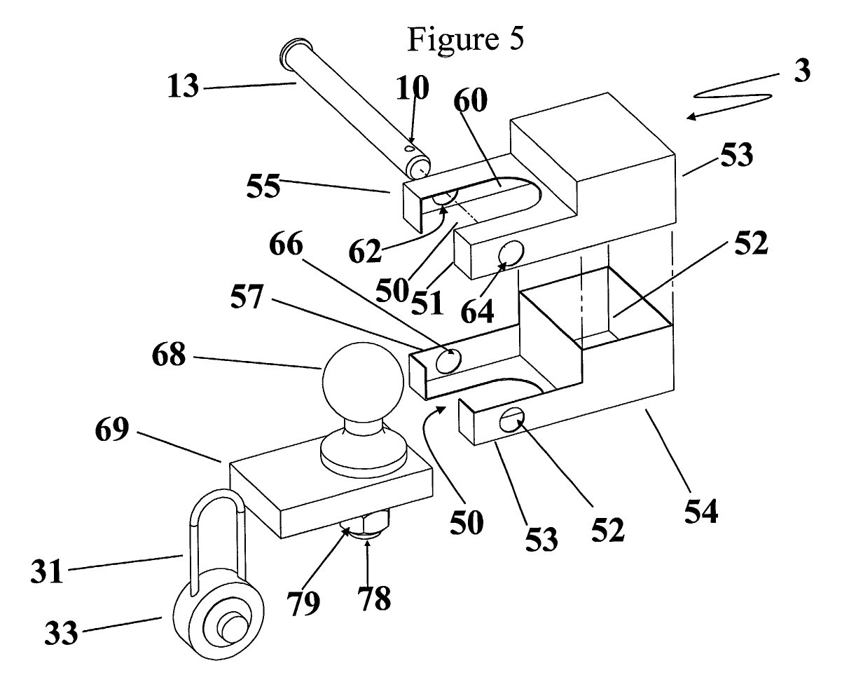

Referring to FIG. 5, in accordance with an alternative preferred embodiment of the valuables storage device of the present invention, an article of manufacture for securing vehicle keys to a permanent part of the vehicle is disclosed and generally designated 3. In order to facilitate the understanding of this embodiment, reference numerals used in conjunction with the alternative preferred embodiment 3 are contained below in Table 2.

### Valuables Storage Device Parts List for Alternative Embodiment

TABLE 2

| Ref. Number | Description |
|---|---|
| 10 | Locking pin hole |
| 13 | Locking pin |
| 31 | Shackle of padlock |
| 33 | Padlock body |
| 50 | Hitch ball notch, upper body |
| 51 | Right locking arm upper body |
| 52 | Right locking hole, lower body |
| 53 | Right locking arm lower body |
| 54 | Lower body |
| 55 | Left locking arm upper body |
| 56 | Cavity of lower body |
| 57 | Left locking arm lower body |
| 58 | Upper body |
| 60 | Hitch ball notch, lower body |
| 62 | Left locking hole upper body |
| 64 | Right locking whole upper body |
| 66 | Left locking hole lower body |
| 68 | Hitch Ball |
| 69 | Hitch tow bar |
| 70 | Fully Assembled device |
| 71 | Assembled locking arms |
| 72 | Left side locking holes, aligned |
| 74 | Assembled hitch ball notch |
| 76 | Right side locking holes, aligned |
| 78 | Shaft of hitch ball |
| 79 | Hitch ball nut |
| 82 | Hole in hitch tow bar |
| 84 | Vehicle bumper |
| 86 | Hole in vehicle bumper designed to hold hitch ball post |

Valuables storage device 3 includes an upper body 58 and a lower body 54 that fit tightly together to form a cavity 56.

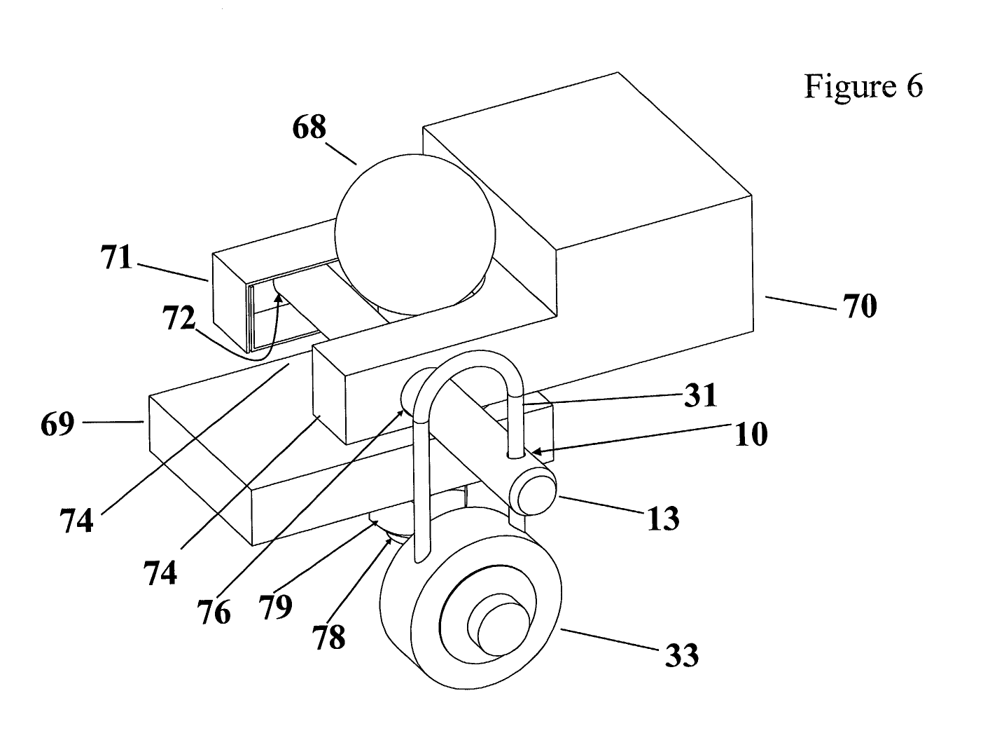

Referring now to FIG. 6, once the upper body 58 and the lower body 54 are fitted together, the device 3 is attached the vehicle by using locking arms 51, 53 and 55, 57 such that hitch ball notch 50 and 60 encircle the hitch ball 68. The locking pin 13 is then inserted through the aligned locking holes 62, 64, 66, 52 in the locking arms 51, 53, 55, 57 of the assembled unit and locked to the hitch ball 68 by inserting the shackle 31 of a combination padlock 33 through locking pin hole 10.

A semi-permanent sealing compound will be packaged with this embodiment for use in securing the threads of the hitch ball 68 to the hitch ball nut 79. This compound can only be release with directly applied temperatures of 450 degrees. This compound will make the hitch ball as permanent a part of the vehicle as it can be short of securing it with a weld. If there is a reason to remove the hitch ball after applying the compound it can be done. However, the ball will not be removable with just a wrench and pliers.

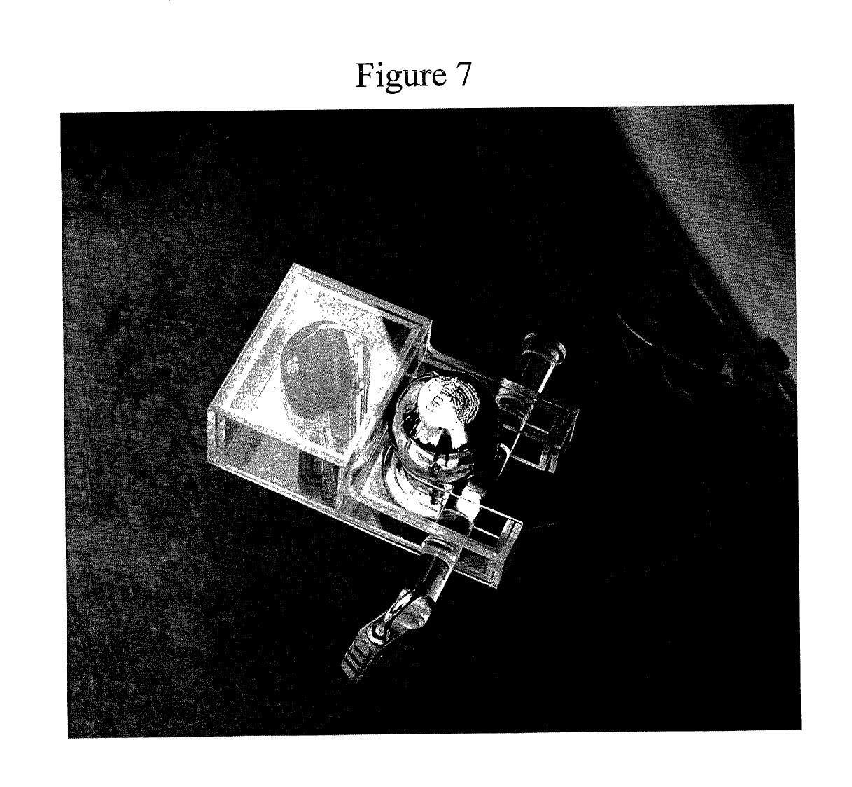

FIG. 7 is a photograph of an alternative preferred embodiment of the valuables storage device of the present invention of FIGS. 5 and 6, and is shown installed in the ball hitch and secured in place with a locking pin and padlock. From this Figure, it is apparent that the valuables storage device 3 is securely attached to the hitch ball 68 of the vehicle, thereby providing a secure storage area for valuables and keys that is readily accessible to the user, but secure enough to prevent unauthorized access to those valuables and keys. The fully assembled device 70 is attached to the hitch ball 68 by sliding the assembled locking arms 71 around the hitch ball 68. This is achieved by centering the hitch ball in the open area of the hitch ball notch 74. Now the assembled locking arms 71 protrude behind the hitch ball 68. This exposes the locking holes, 72 for the left side and 76 for the right side so that the locking pin 13 can be inserted. Thereby securing the fully assembled device 70 to the hitch ball 68. The shackle of the padlock 31 is inserted thru the hole 10 of the locking pin 13 and locked to the padlock body 33.

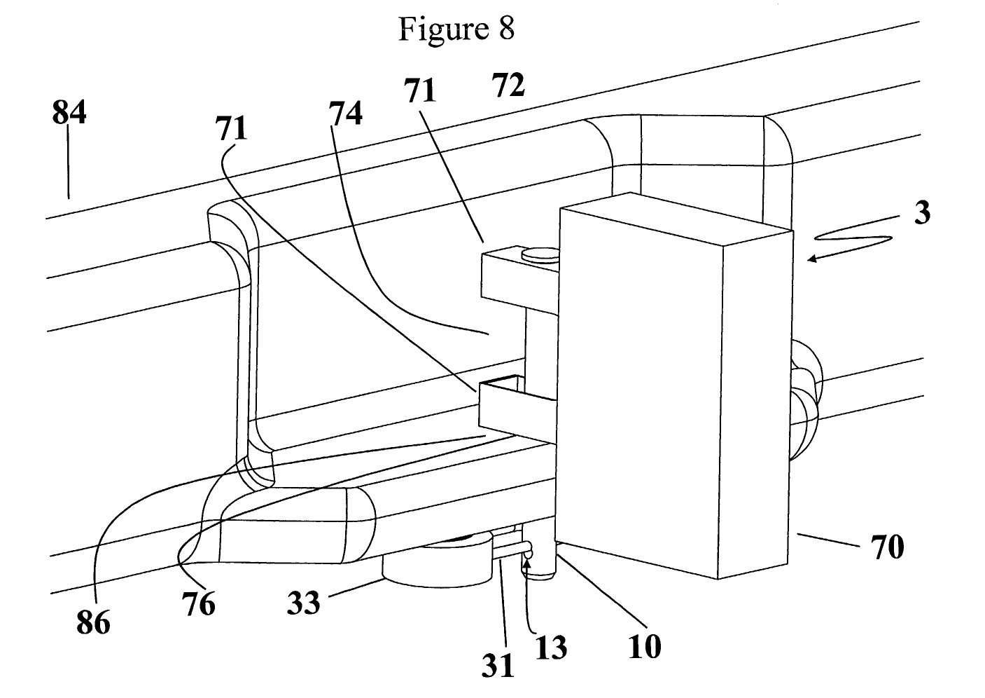

Referring now to FIG. 8, an alternative method of attaching the alternative embodiment 3 of the present invention is shown. More specifically, by the device 3 on its side (vertically oriented instead of horizontally oriented as shown in FIGS. 5-7, the locking pin 13 may be inserted through the locking holes in the assembled locking arms 71 and the hole 86 in a vehicle bumper 84 that is designed to hold the hitch ball. This is so that someone who does not have a hitch ball will not have to purchase one. As long as the bumper has a hole designed for the hitch ball they can make use of this embodiment.

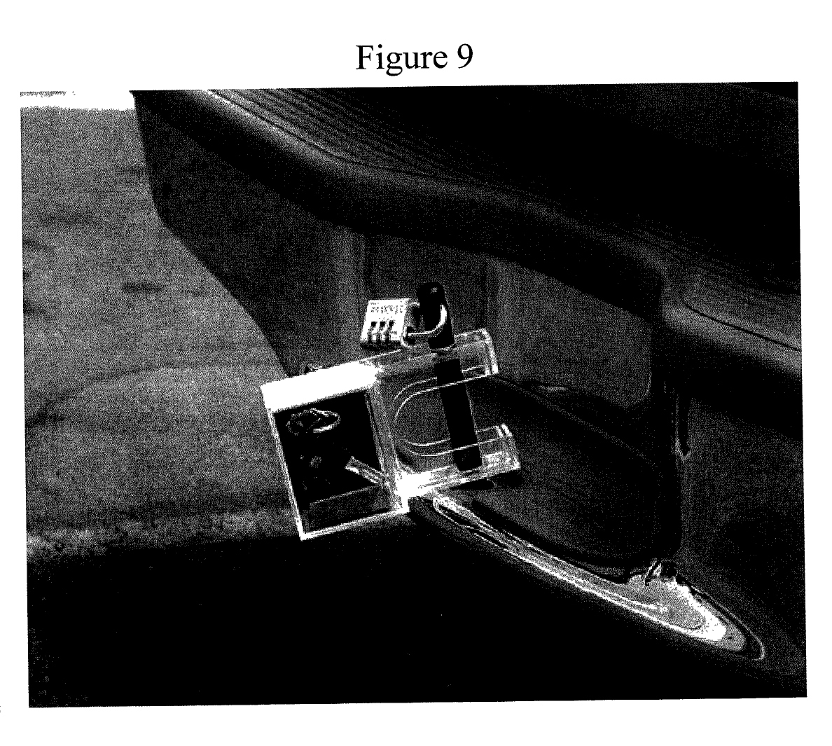

Referring now to FIG. 9, the alternative embodiment of the valuables storage device of FIG. 8 is shown in a photograph as installed on a bumper. From this Figure, it is apparent that the valuables storage device 3 is securely attached to the bumper 84 of the vehicle, thereby providing a secure storage area for valuables and keys that is readily accessible to the user, but secure enough to prevent unauthorized access to those valuables and keys.

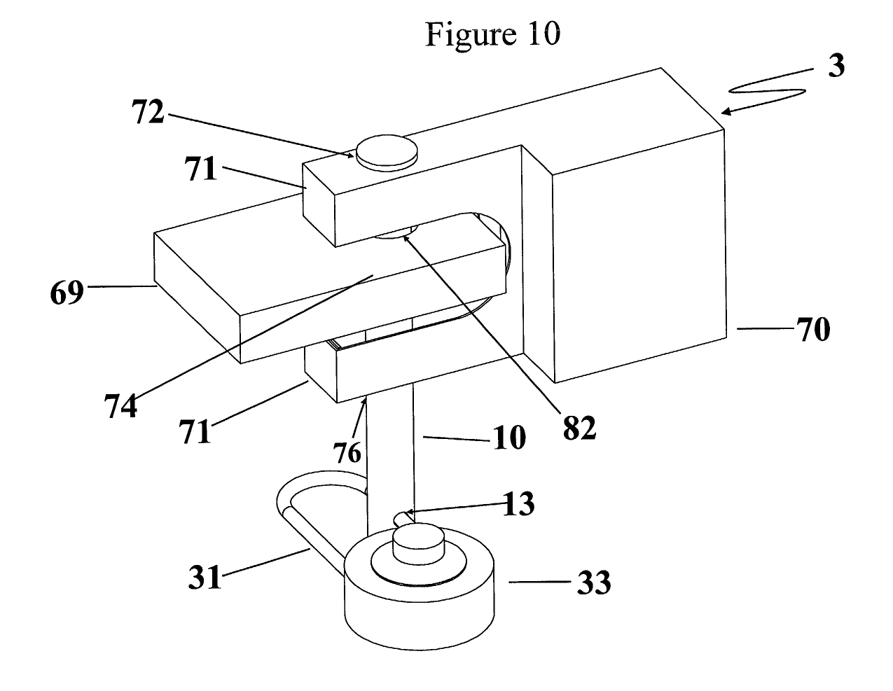

Referring now to FIG. 10, a perspective view of the alternative embodiment of the valuables storage device 3 of the present invention is shown as attached to a vehicle bumper 84 by passing the locking pin 13 through the hole 82 designed to hold the hitch ball in the hitch tow bar 69.

The device 3 is attached to trailer hitch tow bar 69 thru the hole 82 where the hitch ball is designed to fit (hitch ball absent). The locking pin 13 is inserted thru the aligned locking holes 72 and 76 of the assembled device 70 then the padlock shackle 31 is inserted thru the locking pin hole 10 and locked to the padlock body 22 locking the valuables storage device to the vehicle.

Device 3 is attached, on its side, to a bumper 84 through the hole 86 where the hitch ball is designed to fit. The locking pin 13 is inserted through the aligned locking holes 72 and 76 of the assembled device 70 and the hole in the bumper 86. Thus securing the device 70 to the bumper 84. The padlock shackle 31 is inserted through the locking pin hole 10 and the padlock body 33 is locked, securing the device to the vehicle. This use of this version of the valuables storage device eliminates the need to purchase a hitch ball. The only requirement is that there is already a hole in the bumper where the hitch ball is intended to be inserted.

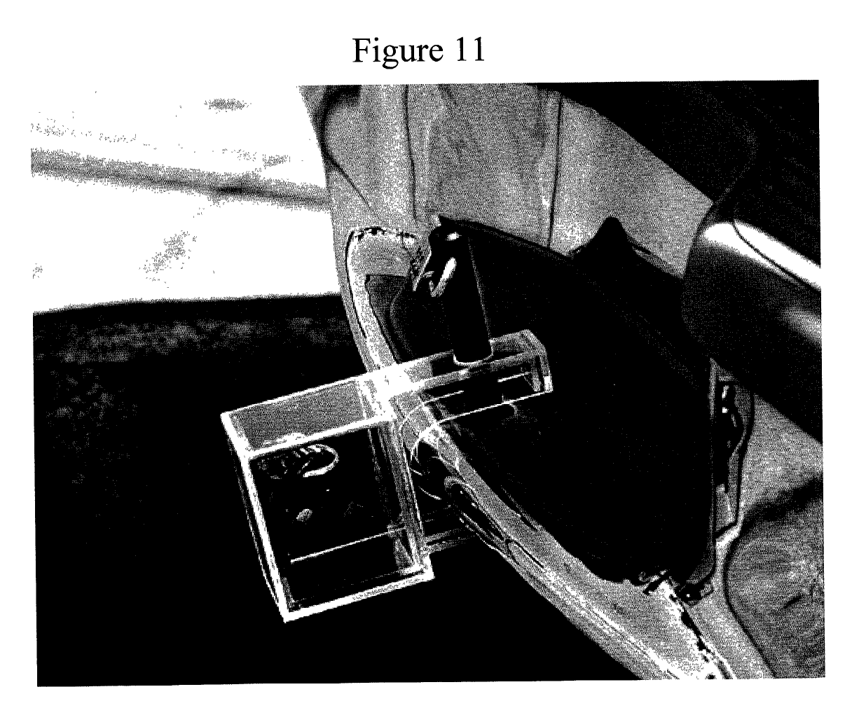

FIG. 11 is a photograph of the alternative embodiment of the valuables storage device 3 of FIG. 10 as installed on a vehicle bumper with the locking pin 13 passing through the hole designed to hold the hitch ball in the hitch tow bar 69.

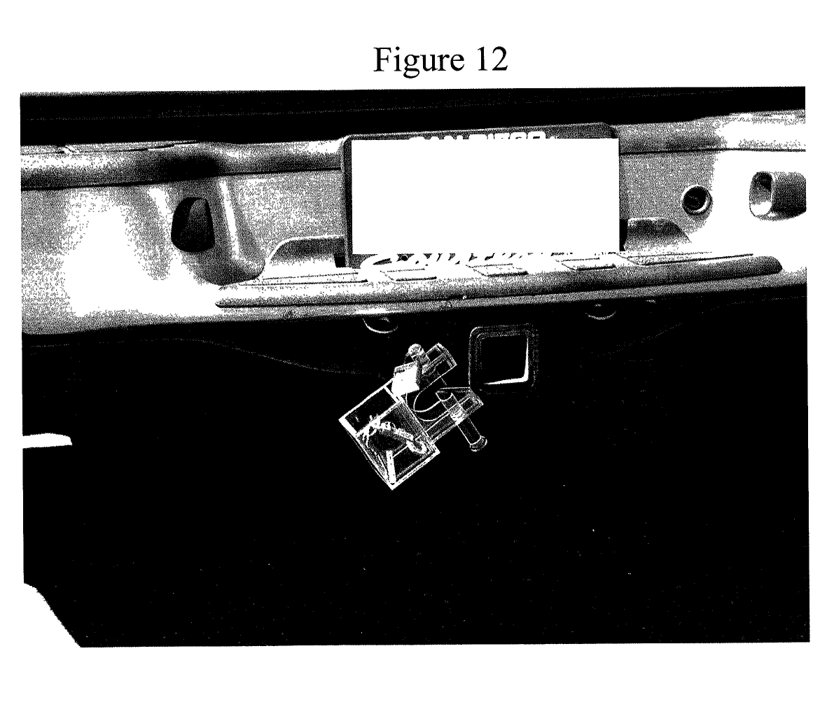

Referring now to FIG. 12, a photograph of the alternative embodiment of the valuables storage device 3 of FIG. 10 is shown as installed on the chain securing loop of a typical hitch. This provides an alternative method of attachment for the device to be secured to the vehicle, and importantly provides an option for use while there is a hitch (not shown this Figure) mounted to the hitch receptacle, such as when the vehicle is towing something.

Detailed Description of a Third Embodiment

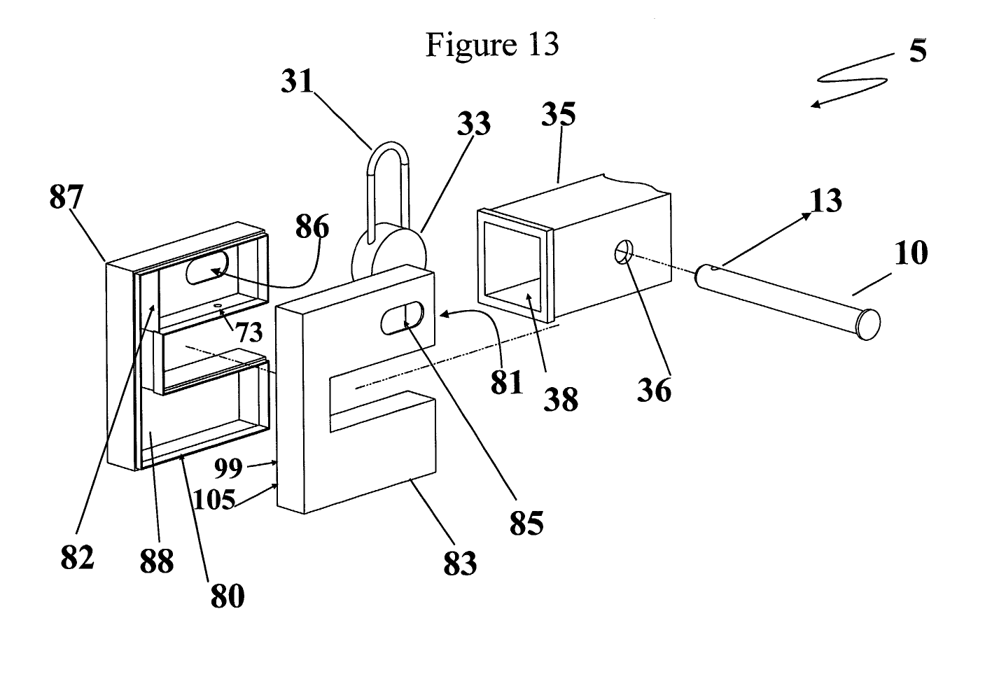

Referring now to FIG. 13, another alternative embodiment of the valuables storage device of the present invention is shown and generally designated 5. In order to facilitate the understanding of this embodiment, reference numerals used in conjunction with the first embodiment are contained below in Table 3.

### Valuables Storage Device Parts List for Another Alternative Embodiment

TABLE 3

| Ref. Number | Description |
|---|---|
| 10 | Locking pin hole |
| 13 | Locking pin |
| 31 | Padlock shackle |
| 33 | padlock body |
| 35 | Hitch receptacle |
| 36 | Hitch receptacle, locking hole |
| 38 | Female end, hitch receptacle |
| 73 | Drain hole |
| 80 | Female, recessed, water resistant lip, left side |
| 81 | Male end of valuables storage device |
| 82 | Water barrier |
| 83 | Right side part |
| 85 | Locking slot, right side |
| 86 | Locking slot, left side |
| 87 | Left side part |
| 88 | Cavity, lower body left side |
| 99 | Cavity in lower body, right side |
| 100 | Fully assembled device |
| 103 | Aligned locking slots |
| 105 | Male water resistant lip, right side |

FIG. 13 is an exploded view of another alternative embodiment of the valuables storage device 5 of the present invention illustrating each, unassembled, individual part, and illustrating how those parts assemble to form a sealed valuables storage device which can be inserted into a vehicle hitch receptacle.

Valuables storage device 5 includes two hollowed out half's (left 87 and right 83) fitting tightly together to form a single cavity by combining lower body left side cavity 88 and lower body right side cavity 99. Once the two halves 83, 87 are fitted together, the male end 81 of the valuables storage device 5 fits tightly into the female end 38 of the receptacle 35 of a trailer hitch.

The male end 81 of the valuables storage device 5 has slots 85, 86 the same diameter as the hole 36 in the trailer hitch receptacle 35. The locking slots 85, 86 in the valuables storage device 5 and the locking holes 36 in the trailer hitch 35 are aligned. Then the round shaft of the locking pin 13 is inserted through the locking holes 36 and locked with a combination lock 33 by inserting the shackle 31 through the locking pin hole 10.

The fully assembled valuables storage device is thereby secured to the vehicle, and the tight fit of the male end 81 of the valuables storage device 5 into the female end 38 of the hitch receptacle 35 keeps the valuables cavity 88, 99 from being pried apart. The fit of the left and right halves is such that it will be water and dust resistant.

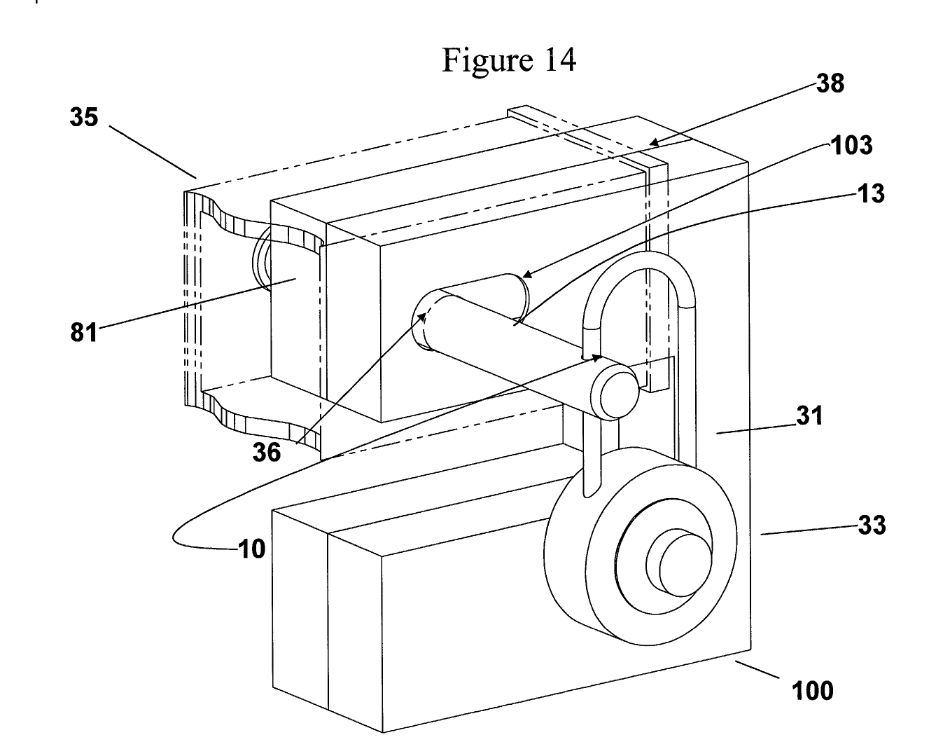

Referring now to FIG. 14, a perspective view of the alternative embodiment of the valuables storage device of FIG. 13 is shown with a portion of the fully assembled unit inserted and locked into a hitch receptacle with the hitch receptacle shown in phantom. As shown, the locking pin 13 passes through aligned locking slots 103 and is secured with padlock 33.

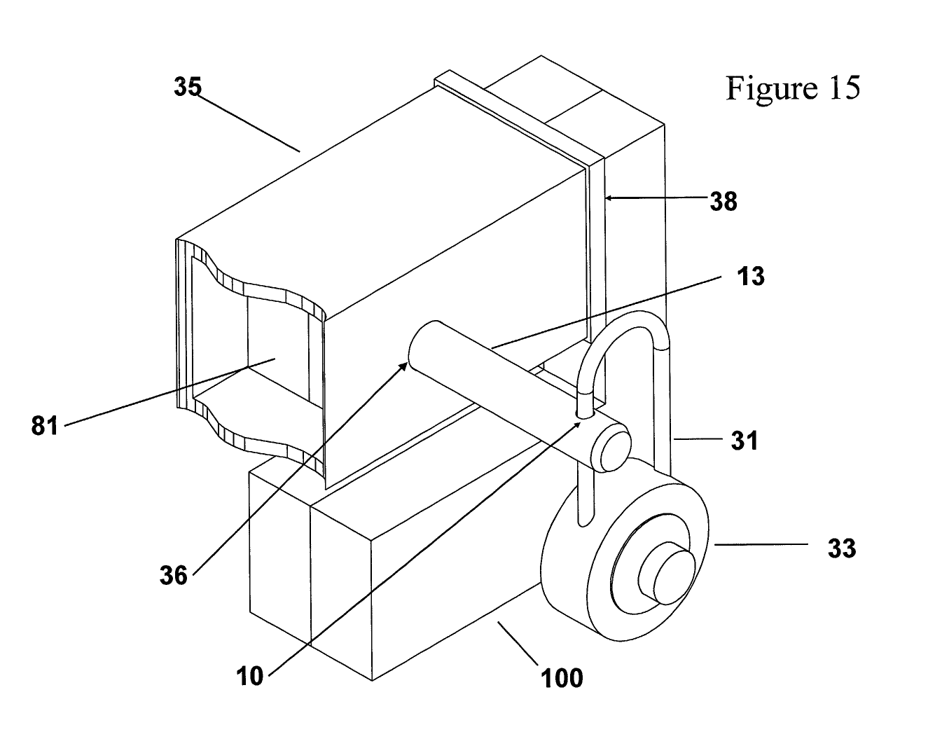

FIG. 15 is a perspective view of the alternative embodiment of the valuables storage device of FIGS. 13 and 14, with the male end 81 of the fully assembled device 5 inserted and locked into a hitch receptacle 35 with a locking pin 13 and padlock 33.

One particular advantage of the valuables storage device 5 is that the valuables cavity tucks down, in a U shape, under the hitch receptacle so that it will protrude less far from the vehicle. This feature makes this version of the valuables storage device less conspicuous, and also minimizes any possible injury resulting from a valuables storage device extending from the vehicle.

The main components of the embodiment are the left side 87 of the hollowed-out valuables storage device for holding valuables, the complimentary right side 83 of the hollowed out valuables securing device for holding valuables once coupled with the left side 87.

In use, the assembly of the valuables storage device 5 includes the valuables being placed in the cavity of the lower body, left side 88 and the cavity of the lower body, right side 99. The left side part 87 is fitted with right side part 83. The water/resistant seal is made by the female, recessed, water resistant lip, left side 80 fitting firmly against the male water resistant lip, right side 105.

Then the male end 81 of the fully assembled device 100 is inserted in the female end 38 of the hitch receptacle. The locking pin 13 is inserted through the aligned locking slots 103 and the hitch receptacle locking holes 36. The padlock shackle 31 is inserted through the locking pin hole 10 and the padlock body 33 is locked securing the device to the vehicle.

A fully assembled device 100 inserted into the female end 38 of the hitch receptacle 35. The locking pin 13 is inserted through the aligned locking slots 103 and the hitch receptacle locking holes 36, securing it. Inserting the pad lock shackle 31 through the locking pin hole 13 and locking the pad lock body 33 secure the locking pin 13. The hitch receptacle 35 is shown in phantom so the aligned locking slots 103 can be seen through the body of the hitch receptacle 35. The fully assembled device 5 is inserted into the female end 38 of the hitch receptacle 35. The locking pin 13 inserted through the aligned locking slots 103 and the hitch receptacle locking holes 3,6 securing it. Inserting the pad lock shackle 31 thru the locking pin hole 13 and into the pad lock body 33 secures the locking pin 13. The hitch receptacle 35 is not shown in phantom showing the device as it will look in place.

The objective of the different embodiments is to provide several different methods of attaching the device to a motor vehicle and different sizes. For example if a vehicle does not have a hitch receptacle required by the First Embodiment then the Second Embodiment that uses the hitch ball for attachment may be used. If the vehicle does not have a hitch ball, the hole in the bumper designed for the hitch ball may be used as a way to attach the device. If the vehicle has a hitch receptacle the owner can still elect to use Second Embodiment and attach it to the Safety Chain Rings that are provided on some types of hitch receptacles.

While there have been shown what are presently considered to be preferred embodiments of the present invention, it will be apparent to those skilled in the art that various changes and modifications can be made herein without departing from the scope and spirit of the invention.

What is claimed is:

1. An Attachable Valuables Storage Device comprising:
a unique article of manufacture for securing vehicle keys and other valuables comprising:
a lower body, formed with a cavity and a male end formed with locking slots;
an upper body, that over-laps the lower body, formed with a cavity and over-lapping edges.
the upper body is positioned on the lower body to seal the cavity. Once assembled the lower body and upper bodies form a water/dust resistant enclosure securable to a permanent part of a vehicle
the primary embodiment is used such: once assembled, containing keys and/or valuables the male end of the valuables storage device fits tightly into the female end receptacle of a trailer hitch receptacle and is held in place with a locking pin and pad lock. The Attachable Valuables Storage Device is thereby secured to the vehicle and the tight fit of the male end of the valuables storage device into the female end of the receptacle keeps the exposed end of the valuables storage device from being pried apart deterring unauthorized use of the keys or valuables.

3. The Attachable Valuables Storage Device set forth in claim 1; further an alternative embodiment, comprising:
a variation on the First Embodiment in the manner in which the device attaches to the vehicle and will also attach to other secure objects such as a fence, water pipe or frame of a bicycle if desired
the alternative embodiment comprises a lower body, formed with a cavity, a male end formed with locking holes, a hitch ball/locking notch and locking arms
an upper body, that over-laps the lower body, formed with a cavity, a male end formed with a locking holes a hitch ball/locking notch and locking arms. Once assembled the lower body and upper body form a water and dust resistant environment.
the locking arms are inserted around the lower, curving, end of a trailer hitch ball, so that the locking notch fits snuggly under the curve of the hitch ball. the locking pin is inserted as to lock the device against the hitch ball curve, and is secured by a pad lock
additionally the locking arms may be inserted around any secure object they will reach round and secured with the locking pin and pad lock. If used such the device does not need the hitch ball to keep the upper and lower body secure; the fit of the inter-locking locking arms and the inserted locking pin holds the two parts together so that the device cannot be pried apart

5. The Attachable Valuables Storage Device set forth in claim 1; further an alternative embodiment, comprising:
a left side formed with a cavity, male water resistant lip and a male end formed with locking slots; a right side formed with a cavity, female recessed water resistant lip, and a male end formed with locking slots
the device is assembled by positioning the left side and right side so that the water resistant lips form a water/dust resistant enclosure securable to a permanent part of a vehicle
this embodiment is used such: once assembled, containing keys and/or valuables the male end of the valuables storage device fits tightly into the female end receptacle of a trailer hitch receptacle and is held in place with a locking pin and pad lock. The Attachable Valuables Storage Device is thereby secured to the vehicle and the tight fit of the male end of the valuables storage device into the female end of the receptacle keeps the exposed end from being pried apart.
